(19) United States
(12) Patent Application Publication
(10) Pub. No.: US 2011/0155487 A1
(43) Pub. Date: Jun. 30, 2011

(54) ELECTRICALLY DRIVEN STRADDLE CARRIER, TERMINAL TRACTOR OR CORRESPONDING

(75) Inventors: Jorma Nurmi, Tampere (FI); Ilkka Annala, Tampere (FI)

(73) Assignee: CARGOTEC FINLAND OY, Tampere (FI)

(21) Appl. No.: 12/997,729

(22) PCT Filed: Jun. 12, 2009
(86) PCT No.: PCT/FI2009/050507

§ 371 Date: Mar. 16, 2011

(30) Foreign Application Priority Data
Jun. 13, 2008 (FI) 20085584

(51) Int. Cl. B60K 1/04

(52) U.S. Cl. 180/65.1

(57) ABSTRACT

An electrically-driven container straddle carrier, terminal tractor or equivalent free-travel device that runs on rubber tires and handles containers. The device includes a repeatedly-chargeable electric power storage and an automatic charging system connected to the power storage, which is arranged to couple to an external source of electric power for a part of the work cycle of the device handling containers for charging the electric power storage without disturbing the normal work cycle of the device. When the device is a transport straddle carrier that operates in a cargo terminal between a crane and a container interchange area, the automatic charging system includes a power supply station arranged in the terminal area, provided with a power supply head, whereby the container straddle carrier includes a charging head connected to the power storage and coupling to the power supply station.

The invention relates to handling containers at ports and terminals, particularly by means of so-called container straddle carriers, terminal tractors or equivalents. In more detail, the invention relates to an electrically-driven container straddle carrier, terminal tractor or equivalent free-travel device which runs on rubber tyres and handles containers.

Container handling devices used at ports and cargo terminals have traditionally been driven by diesel engines. Particularly recently, the price of diesel fuel has gone up considerably, due to which there is a tendency to decrease fuel consumption. Container handling devices are large and heavy machines and thus consume a lot of fuel. A consequence of high fuel consumption naturally is that the exhaust discharges of the container handling devices are great. Of course, burning fuel creates CO₂ emissions which should already be decreased due to the pressures of climate change. Burning diesel fuel further causes fine-particle emissions detrimental to health. Large ports and cargo terminals are often located in the immediate vicinity of towns or in large port towns even in the vicinity of the centre, whereby fine-particle emissions can considerably worsen the air quality of the environment and even cause a health risk. Therefore, disadvantages caused by burning (diesel) fuel have to be decreased. An ideal solution from the viewpoint of both economy and the environment would be to totally eliminate diesel engine drives in container handling devices.

Fuel cell technology could be considered a perfect solution in view of present knowledge, but it is not yet technically ready to be implemented and its utilisation will possibly be delayed until the far future.

In connection with container handling devices is previously known a full-electric drive, but not in container straddle carriers and terminal tractors but in gantry cranes (RTG—Rubber Tyred Gantry Crane). Such a system is described in e.g. Chinese published application No. CN101104498. From this specification is known an arrangement in which electric conductors are arranged in straight lines in the terminal area and a gantry crane is provided with a current collector via which electric power is conveyed to the electric motors of the gantry crane. The crane is connected to the electric conductors all the time via the current collector. This kind of application can indeed be used in the case of the gantry crane, because the gantry crane runs in the terminal area along the same straight and long run lines. However, this system cannot be applied to container straddle carriers and terminal tractors, because it would limit the appropriate use of container straddle carriers and terminal tractors too much and even prevent it, in which use these devices have to be able to drive varying and winding routes in the terminal area.

Hybrid drive systems are previously known for the part of container handling devices. A hybrid drive system in this context refers to a system which comprises a diesel generator set producing electric power and a combination constituted by electric motors to which can also be connected a battery system operating as an intermediate storage for power. Such intermediate storage is necessary in order not to dimension the diesel generator set too large to cover all possible maximum power requirements. Even though the battery technology is developing strongly, problems with size, weight and costs are related to battery drive in heavy container handling devices provided with a hybrid drive system. The case is indeed of continuous-drive mobile work devices even the average output of which is in the range of 60 . . . 80 kW and the maximum output in the range of 300 kW.

Battery drive is still possible as the recent developed battery technology employs NiMH batteries and, in the near future, in higher outputs also Li-Ion batteries are developing with respect to their life and costs. In a continuously used device (even 24/7 in use), the traditional replacement or charging of batteries known e.g. from small fork-lift trucks e.g. during the night is not possible. The result would be too much extra replacement work or too long shutdowns. Such a way of working in which the battery is used until empty e.g. during a work shift is also unsuitable for a straddle carrier or terminal tractor, because it would lead to a too large battery size and still at the same time a too short battery life.

Of German published application DE102004010988 is further known such a hybrid drive system intended for gantry cranes in which a diesel generator produces electricity with which the electric motors of the crane are operated. Electric current is also conveyed to a combination of batteries and super condensers operating as the intermediate storage of power from which it is taken to cover possible maximum power requirements. Because this system also employs an effective diesel engine in producing electricity, the exhaust discharges of the system, particularly its CO₂ emissions, are considerable despite the hybrid drive.

The object of the present invention is to provide a novel drive system for container handling devices, particularly for container straddle carriers, terminal tractors and equivalents, by means of which an improvement is provided in relation to recent systems and by means of which many disadvantages related to hybrid drive systems are avoided.

For achieving the objects described above and introduced later, the invention is mainly characterised by that the device is provided with a repeatedly-chargeable electric power storage and an automatic charging system connected to the power storage which is arranged to couple to an external source of electric power for a part of the work cycle of the device handling containers for charging the electric power storage without disturbing the normal work cycle of the device.

As the electric power storage is used one or more chargeable batteries, one or more super condensers or a combination of batteries and super condensers. When the device according to the invention is a transport straddle carrier which operates in a cargo terminal, such as a port, between a crane and a container interchange area, the automatic charging system comprises a power supply station arranged in the terminal area advantageously into connection with the container interchange area, provided with a power supply head, whereby the container straddle carrier is provided with a charging head connected to the power storage and coupling to the power supply station. The charging head is suitably elastic and it is installed in the container straddle carrier so that the container straddle carrier is drivable to the power supply station so that the charging head automatically couples to the power supply head.

When the device according to the invention is a stacking container straddle carrier which operates in a terminal area conveying and arranging containers into container rows or stacks and out of them, the automatic charging system comprises current conductors advantageously arranged in the terminal area in the operating range of the container straddle carrier supported on supporting columns and the container straddle carrier is provided with a charging head connected to the power storage and coming into contact with the current conductors during the work cycle. The current conductors are then arranged above the container row/stack and the charging head is installed on top of the container straddle carrier, whereby the charging head is arranged into contact with the current conductors during the stacking work of the container straddle carrier.

In the case of a terminal tractor, the automatic charging system comprises current conductors arranged in the terminal area at a specific point in a recurring route of the terminal tractor supported on supporting columns or a power supply point arranged below an RTG crane at a container unloading/loading point and the actual terminal tractor is provided with a charging head connected to the power storage which head is arranged to come into contact with the current conductors or said power supply point.

The invention provides several advantages in relation to prior art the most important advantage of which can be considered the fact that the system according to the invention totally avoids using a diesel generator and a diesel engine drive. Along with this, the system according to the invention is totally non-polluting in use. Other advantages and characteristics of the invention will become evident in the following detailed description of the invention to the described embodiments of which the invention is not intended to be narrowly limited.

The invention will now be described by way of examples with reference to the figures of the accompanying drawing.

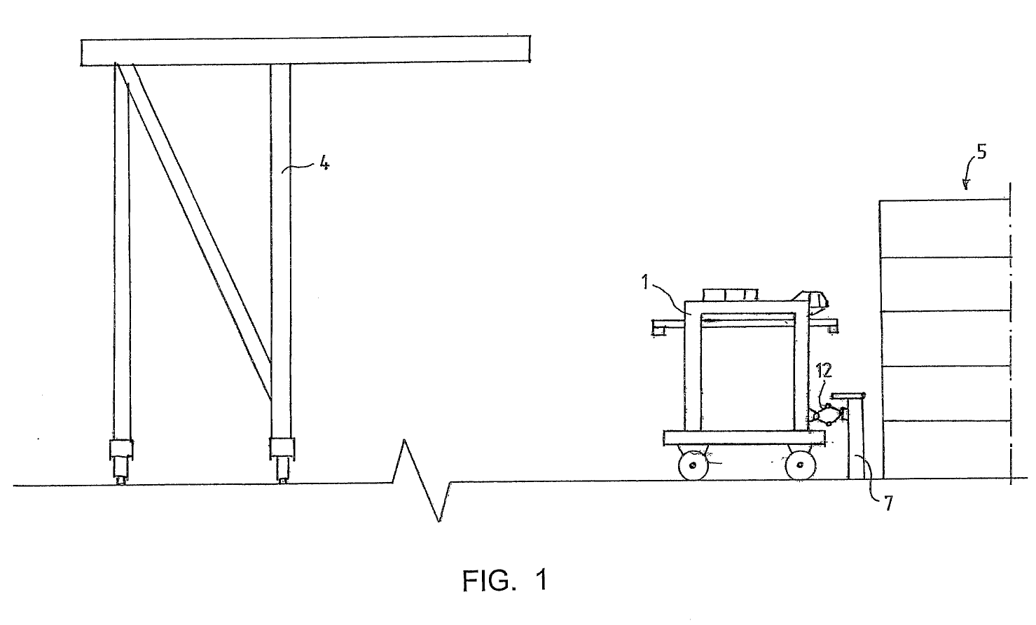

FIG. 1 totally schematically shows applying a system according to the invention to a transport straddle carrier i.e. a transporting container straddle carrier.

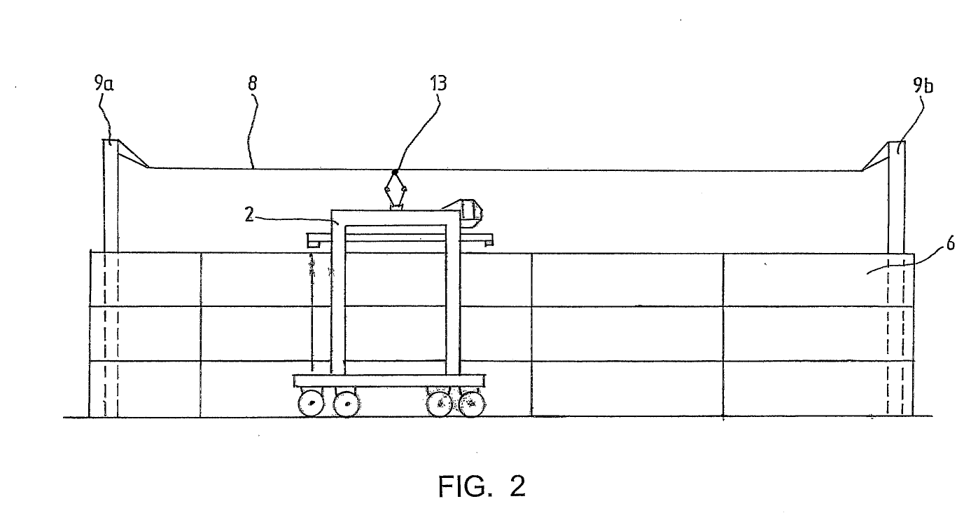

FIG. 2 equivalently shows applying a system according to the invention to a stacking container straddle carrier.

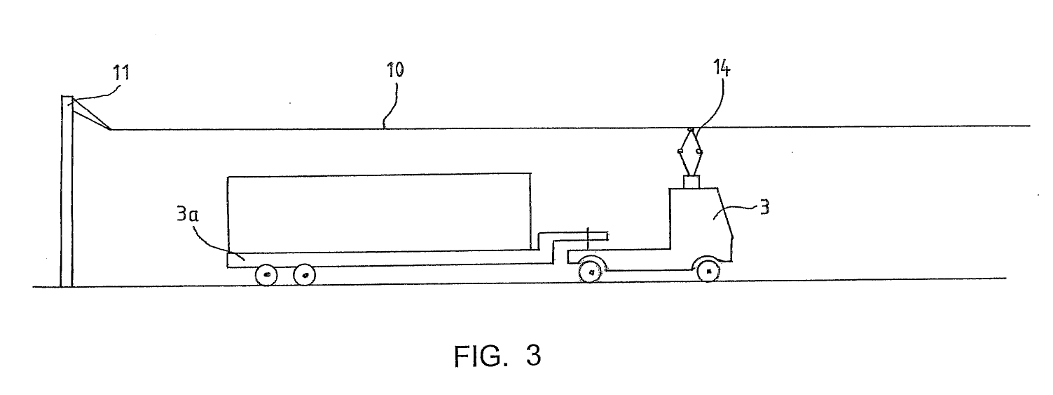

FIG. 3 again shows applying a system according to the invention to a terminal tractor.

FIG. 1 thus schematically shows a transport straddle carrier 1 which in the example of the figure operates between a quay crane 4 and a container interchange area 5 conveying containers from the quay crane 4 to the container interchange area 5 and vice versa. The transport straddle carrier 1 is provided with rubber tyres and it travels freely in a loading area, such as a port. The transport straddle carrier 1 is provided with an electric drive, particularly with a modern AC electric drive, and with a required number of chargeable batteries or a chargeable battery of required size. In the case of the transport straddle carrier 1, the electric drive is used for both the transport run of the transport straddle carrier and the lifting motion of the containers so that the electric drive motors comprise drive, lift and transfer motors and required auxiliary devices and motors. The drive motors and batteries are not separately shown in the figures. The battery/batteries then operate as the power storage from which the electric motors of the straddle carrier obtain their required driving power. In addition to the battery/batteries, it is also possible to use super condensers or equivalent super condenser technique as the power storage. Advantages of super condensers are that they are light, service-free, long-life and have a high charging capacity, but a disadvantage is that they cannot deliver high powers for long, only for a short time. Then, it could be considered that, for continuous, long-term use and e.g. for transfer drive, the electric drive of the transport straddle carrier 1 obtains its required power from batteries and equivalently e.g. the requirement of maximum power, e.g. power required by lifting motion, is provided with super condensers in addition to the batteries. As a further alternative can be considered that the whole power storage is constituted of one or more super condensers.

Because the transport straddle carrier 1 has to be substantially free-travel for the whole time in the loading area in order to be able to convey containers from one desired place to another, it is not continuously and for the whole time connected to an external source of electric power. The transport straddle carrier 1 cannot either be like e.g. a conventional battery-driven vehicle connected non-stop to an external source of electric power for it to be operational substantially for the whole time. In order for the transport straddle carrier 1 be operational for the whole time, the batteries functioning as the chargeable power storage have to be repeatedly charged. For this reason and for obtaining an adequately long life for the batteries, the straddle carrier 1 is provided with an automatic charging system by which charging the batteries can be performed normally at a suitable point in the work cycle without substantially disturbing the progress of the work cycle. The actual charging event is only a small part of the whole work cycle of the device and it is arranged into connection with the work cycle so that the normal work cycle will not considerably be disturbed of the charging event. In the example according to FIG. 1, this has been solved so that in the container interchange area 5 is located a power supply station 7 provided with a power supply head e.g. in a column or equivalent in which is brought either direct current or three-phase current. Equivalently, the transport straddle carrier 1 is provided with a charging head 12 which is arranged e.g. in the right front column of the straddle carrier. The charging head 12 is composed elastic in the drive direction and arranged at such a height that it touches the power supply head of the power supply station 7 when the straddle carrier drives the charging head 12 fast to the power supply station 7. In the charging event, this is a case of a so-called auto plug-in operation.

FIG. 2 shows applying a system according to the invention to a stacking container straddle carrier which is designated with reference number 2. The stacking container straddle carrier 2 is provided with rubber tyres and it travels freely in a loading area. Such a stacking container straddle carrier 2 is operated in a cargo port or equivalent terminal area where the straddle carrier 2 conveys and arranges containers in container rows and stacks 6 from which the containers are equivalently conveyed to further transport e.g. with container vehicles and trailers or perhaps with terminal tractors.

According to the invention, the container straddle carrier 2 is provided with an electric drive, like in the case of the transport straddle carrier in FIG. 1. The electric drive is also implemented in an equivalent way, e.g. with an AC electric drive, and with a required number of chargeable batteries or a chargeable battery of required size. The electric drive is used for moving the container straddle carrier 2 and to the lifting motion and stacking of the containers. Also in FIG. 2, the drive motors and batteries are not separately shown. The use of batteries and/or super condensers as the power storage and their properties in this purpose are equivalent to the ones already described in connection with FIG. 1.

As in the case of the transport straddle carrier of FIG. 1, also the stacking container straddle carrier 2 according to FIG. 2 has to be substantially free-travel for the whole time in the loading area in order to be able to convey containers from one desired place to another, it is not continuously and for the whole time connected to an external source of electric power. Also in the arrangement according to this embodiment, the container straddle carrier 2 cannot be like e.g. a conventional battery-driven vehicle connected non-stop to an external source of electric power for it to be operational substantially for the whole time. In order for the container straddle carrier 2 be operational for the whole time, the batteries functioning as the chargeable power storage have to be repeatedly charged. For this reason and for obtaining an adequately long life for the batteries, the container straddle carrier 2 is also provided with an automatic charging system by which charging the batteries can be performed normally at a suitable point in the work cycle without substantially disturbing the progress of the work cycle. The actual charging event is only a small part of the whole work cycle of the device and it is arranged into connection with the work cycle so that the normal work cycle will not considerably be disturbed of the charging event.

In the example according to FIG. 2, the container straddle carrier 2 is thus provided with an automatic charging system by which charging the batteries functioning as the power storage can be normally and repeatedly performed at a suitable point in the work cycle without substantially disturbing the progress of the work cycle. In the example according to FIG. 2, this was solved so that in the operating range of the container straddle carrier 2, advantageously on top of a container stack 6 is arranged current conductors 8 supported on supporting columns 9a, 9b in which either direct current or three-phase current is brought. Equivalently, the container straddle carrier 2 is provided with an automatic charging head 13 which is arranged e.g. on top of the frame of the container straddle carrier 2. The charging head 13 can be e.g. a current collector equivalent to the one used in electric trains and trams, among others. The charging head 13 is then in contact with the current conductors 8 during the stacking work of the container straddle carrier 2. The charging head 13 is by no means in contact with the current conductors 8 for the whole time, but the current conductors are arranged in the operating range of the container straddle carrier 2 so that the actual charging event, whereby said charging head 13 is in contact with the current conductors 8, is only a small part of the whole work cycle so that the normal work cycle will not be considerably disturbed by the charging event.

FIG. 3 shows applying a system according to the invention to a terminal tractor which is designated with reference number 3. A trailer connected to the terminal tractor is equivalently designated with reference 3a. In the case of the terminal tractor 3, a charging head 14 is located on the roof of the cabin and it can be similar to the charging head 13 of the stacking container straddle carrier 2 described above. Current conductors 10 and supporting columns 11 supporting them are in this case arranged and located e.g. at a specific point of a recurring route of the terminal tractor 3, whereby a rapid charge of batteries is performed always when the terminal tractor 3 passes the point in question. Either in this case, the charging head 14 cannot be in contact with the current conductors 10 for the whole time. In the case of the terminal tractor 3, the charging of batteries can also be implemented so that e.g. below a rubber tyred gantry (RTG) crane at a container unloading/loading point is arranged a power supply point in which the charging head 14 of the terminal tractor 3 is coupled for the time of unloading/loading cargo. Then, the charging head can or perhaps should be of different type than the one shown in FIG. 3. Then, as the charging head can be considered using e.g. an arrangement similar to the one shown in the example according to FIG. 1.

The system according to the invention is thus applied to devices the weight of which as such is considerably large, even over 100 tons. In the invention, the size of the batteries is relatively small in relation to the weight of the device, usually in the range of 30 . . . 80 kWh. One work cycle uses about 5% of the charging capacity of the battery/batteries, i.e. in the range of 1.5 . . . 4 kWh. In order to obtain a long life for the batteries operating as the power storage, the device according to the invention is provided with an automatic charging system so that the charging of the power storage can repeatedly be done normally at a suitable point in the work cycle without considerably disturbing the progress of the work cycle. With this way of automatically repeated charging, the size of the power storage can be kept relatively small and the long life of the power storage can be achieved.

The invention was described above by way of examples with reference to the figures of the enclosed drawing. The invention is not, however, solely limited to the embodiments shown in the figures, but the various embodiments of the invention can vary within the scope of the inventive idea presented in the enclosed claims.

1. An electrically-driven container straddle, carrier or terminal tractor free-travel device running on rubber tires and handling containers, characterised in that the device comprising:
a repeatedly-chargeable electric power storage; and
an automatic charging system connected to the power storage, which system is arranged to couple to an external source of electric power for a part of a work cycle of the device handling containers for charging the electric power storage without disturbing a normal work cycle of the device.

2. The device according to claim 1, wherein the electric power storage at least one chargeable battery.

3. The device according to claim 1, wherein the electric power storage at least one super consenser or a combination of at least one battery and at least one super condenser.

4. The device according to claim 1, wherein the device is a container straddle carrier that is configured to operate in a cargo terminal between a crane and a container interchange area claim 1, wherein the automatic charging system comprises a power supply station arranged in the terminal area into connection with the container interchange area, wherein the power supply station comprises a power supply head, wherein the container straddle carrier comprises a charging head connected to the power storage and coupling to the power supply station.

5. The device according to claim 4, wherein the charging head is elastic and is installed in the container straddle carrier so that the container straddle carrier is driveable in the power supply station so that the charging head automatically couples to the power supply head.

6. The device handling containers according to claim 1, wherein the device is a stacking container straddle carrier that operates in a terminal area conveying and is configured to arrange containers into and out of container rows and stacks, wherein the automatic charging system comprises current conductors arranged in the terminal area in the operating range of the container straddle carrier supported on a supporting columns, and wherein the container straddle carrier comprises a charging head connected to the power storage and coming into contact with the current conductors for a part of the work cycle.

7. The device according to claim 6, wherein the current conductors are arranged above a container row/stack, and wherein the charging head is installed on top of the container straddle carrier, whereby the charging head is arranged into contact with the current conductors during the stacking work of the container straddle carrier.

8. The device handling containers according to claim 1, wherein the device is a terminal tractor configured to convey containers in a terminal area, wherein the automatic charging system comprises current conductors arranged at a specific point in the terminal area in a recurring route of the terminal tractor supported on supporting columns or a power supply point arranged below rubber tired gantry crane at a container unloading/loading point, and wherein the terminal tractor comprises a charging head connected to the power storage that head is arranged to come into contact with the current conductors or said power supply point.

9. The device according to claim 4, wherein the cargo terminal comprises a port.
